(19) United States
(12) Patent Application Publication
(10) Pub. No.: US 2010/0322316 A1
(43) Pub. Date: Dec. 23, 2010

(54) MOVING-PICTURE ENCODING APPARATUS AND DECODING APPARATUS

(76) Inventors: Tomonobu Yoshino, Fujimino-shi (JP); Sei Naito, Fujimino-shi (JP); Shigeyuki Sakazawa, Fujimino-shi (JP)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/814,634

(22) Filed: Jun. 14, 2010

(30) Foreign Application Priority Data
Jun. 22, 2009 (JP) 2009-147583

(51) Int. Cl. H04N 7/32

(52) U.S. Cl. 375/240.16; 375/240.12; 375/E07.125

(57) ABSTRACT

As the encoding mode, a moving-picture encoding apparatus includes an encoding mode that relies only on inference based on encoding information of a previously encoded unit block so as to encode a picture of a unit block. The encoding information in this encoding mode is imparted with secondary encoding information for improving the prediction performance, e.g., MV information. The MV information is produced by an MV-information producing unit 21 to which an input picture and MV information in a previously encoded MB are input. A locally-decoded picture producing unit 22 produces a locally-decoded picture (pixel value) of the previously encoded MB. As the secondary encoding information, a DC component of an orthogonal transformation result relative to a prediction error or a value equivalent to an average value of prediction errors can also be used.

The present application is claims priority of Japanese Patent Application Serial No. 2009-147583, filed Jun. 22, 2009, the content of which is hereby incorporated by reference in its entirety.

### BACKGROUND OF THE INVENTION

1. Field of the Invention

The present invention relates to a moving-picture encoding apparatus and a decoding apparatus, and more particularly, relates to a moving-picture encoding apparatus and decoding apparatus capable of performing high-compression encoding and decoding on a high-resolution picture and improving a prediction performance.

2. Description of the Related Art

A moving-picture encoding apparatus that comprises encoding modes of which the predicting methods differ and that encodes a moving picture by adaptively switching encoding conducted by these encoding modes by each unit block is well known. An encoding mode that relies only on inference based on encoding information of a previously encoded unit block so as to encode a picture of the unit block is also known as the encoding mode. Herein, the unit block indicates a unit by which the encoding modes are switched. In Non-Patent Document 1, the unit block corresponds to a macro block (MB).

Non-Patent Document 1 describes a skip encoding mode in which in a unit block (macro block: MB. Hereinafter, MB is equivalent to the unit block), there is no encoding information other than an encoding mode identifier. In the skip encoding mode, an encoding process that is similar to prediction encoding of a motion compensation is performed. However, in the skip encoding mode, upon decoding, motion vector information inferred based on surrounding previously encoded MBs is used as information about the motion vector. Thus, in the MB, the information about the motion vector is not encoded. As a decoded value of a picture, a pixel value of a reference destination of the motion compensation is used as it is. Therefore, information about a prediction error is not encoded, either.

FIG. 10 is a block diagram showing the configuration of a conventional skip encoding unit. The skip encoding unit includes: a skip-MV-information producing unit 101; a locally-decoded picture (pixel-value) producing unit 102; and a skip-encoding-mode-identifier producing unit 103.

The skip-MV-information producing unit 101 is input with the motion vector (MV) information in a previously encoded MB, and outputs the MV information in an adjacent, previously encoded MB as MV information of the MB. The locally-decoded picture (pixel-value) producing unit 102 is input with the MV information from the skip-MV-information producing unit 21 and a locally-decoded picture (pixel value) of the previously encoded MB so as to produce a locally-decoded picture (pixel value) of the MB. The locally-decoded picture (pixel value) of the MB is produced as follows: a locally-decoded picture (pixel value) of a reference destination indicated by the MV information is acquired, and the pixel value is used as the locally-decoded picture (pixel value) of the MB. The locally-decoded picture (pixel value) produced by the locally-decoded picture (pixel-value) producing unit 22 is used as the locally-decoded picture used when another MB is encoded.

The skip-encoding-mode-identifier producing unit 103 produces a skip-encoding-mode identifier indicating that the MB is encoded by the skip encoding. The skip-encoding-mode identifier is 1-bit flag information, for example, and results in the encoding mode information. The skip-encoding-mode identifier from the skip-encoding-mode-identifier producing unit 23 is output, as the encoding information, to an entropy encoding unit (not shown).

[Non-Patent Document 1] Joint Video Team (JVT) of ISO/IEC MPEG and ITU-VCEG, “Text of ISO/IEC 14496 10 Advanced Video Coding 3^{rd} Edition,” July 2004.

When the skip encoding mode described in Non-Patent Document 1 is utilized, it becomes possible to significantly inhibit code amount in spite of occurrence of a decrease in prediction performance. However, it is known that high-compression encoding on a high-resolution picture requires a higher prediction performance than the skip encoding mode even though more code amount is consumed. According to a technique in Non-Patent Document 1, even though it is possible to significantly inhibit code amount, the above-described requirement cannot be satisfied, which is a problem.

### SUMMARY OF THE INVENTION

An object of the present invention is to solve the above problems and to provide a moving-picture encoding apparatus and a decoding apparatus capable of improving a prediction performance in an encoding mode that relies only on inference based on encoding information of a previously encoded unit block so as to encode a picture of the unit block.

In order to accomplish the object, the first feature of this invention is that a moving-picture encoding apparatus, including encoding modes different in predicting method, for encoding a moving picture by adaptively switching the encoding modes by each unit block, the apparatus comprises an encoding mode that relies only on inference based on encoding information of a previously encoded unit block to encode a picture of a unit block, and a unit for imparting the encoding information in the encoding mode with secondary encoding information used for improving a prediction performance.

The second feature of this invention is that the moving-picture encoding apparatus, wherein the secondary encoding information is motion vector information of the unit block.

The third feature of this invention is that the moving-picture encoding apparatus, wherein the secondary encoding information is a DC component of an orthogonal transformation result relative to a prediction error of the unit block.

The fourth feature of this invention is that the moving-picture encoding apparatus, wherein the secondary encoding information is a value equivalent to an average value of the prediction errors of the unit block.

The fifth feature of this invention is that the moving-picture encoding apparatus, wherein as the secondary encoding information, one of motion vector information of the unit block and a DC component of an orthogonal transformation result relative to a prediction error of the unit block is selectable.

The sixth feature of this invention is that the moving-picture encoding apparatus, wherein as the secondary encoding information, one of motion vector information of the unit block and a value equivalent to an average value of prediction errors of the unit block is selectable.

The seventh feature of this invention is that the moving-picture encoding apparatus, comprises a locally-decoded picture producing unit for acquiring a prediction value of the unit block from a locally-decoded picture of the previously encoded unit block by using the motion vector information to produce the prediction value as a pixel value of a locally-decoded picture of the unit block.

The eighth feature of this invention is that the moving-picture encoding apparatus, comprises a locally-decoded picture producing unit for calculating a value equivalent to an average value of the prediction errors from the DC component of the orthogonal transformation result relative to the prediction error, adding the thus calculated value to a prediction value of an encoding mode that relies only on inference based on the encoding information of the previously encoded unit block so as to encode a picture of the unit block thereby to produce the thus calculated value as a pixel value of a locally-decoded picture of the unit block.

The ninth feature of this invention is that the moving-picture encoding apparatus, comprises a locally-decoded picture producing unit for adding a value equivalent to the average value of the prediction errors to a prediction value of the encoding mode that relies only on inference based on the encoding information of a previously encoded unit block so as to encode a picture of the unit block thereby to produce the thus calculated value as a pixel value of a locally-decoded picture of the unit block.

The tenth feature of this invention is that the moving-picture encoding apparatus, comprises a locally-decoded picture producing unit configured so that according to selection of one of the motion vector information and the DC component of the orthogonal transformation result relative to the prediction error, the motion vector information is used to acquire a prediction value of the unit block from a locally-decoded picture of the previously encoded unit block, and the thus acquired prediction value is produced as a pixel value of the locally-decoded picture of the unit block, or from the DC component of the orthogonal transformation result relative to the prediction error, a value equivalent to an average value of the prediction errors is calculated, the thus calculated value is added to a prediction value of the encoding mode that relies only on inference based on the encoding information of the previously encoded unit block so as to encode a picture of the unit block, and the thus calculated value is produced as the pixel value of the locally-decoded picture of the unit block.

The eleventh feature of this invention is that the moving-picture encoding apparatus, comprises a locally-decoded picture producing unit configured so that according to selection of one of the motion vector information and the value equivalent to an average value of the prediction errors, the motion vector information is used to acquire a prediction value of the unit block from a locally-decoded picture of the previously encoded unit block, and the thus acquired prediction value is produced as a pixel value of the locally-decoded picture of the unit block, or the value equivalent to the average value of the prediction errors is added to a prediction value of an encoding mode that relies only on inference based on encoding information of a previously encoded unit block so as to encode a picture of the unit block, and the thus calculated value is produced as the pixel value of the locally-decoded picture of the unit block.

The twelfth feature of this invention is that a moving-picture decoding apparatus for decoding encoding information generated by a moving-picture encoding apparatus having the first feature, the moving-picture decoding apparatus comprises a decoding unit for decoding a picture of a unit block, the picture being encoded by an encoding mode for encoding that relies only on inference based on encoding information of a previously encoded unit block, by also using secondary encoding information imparted to the encoding information of the unit block.

The thirteenth feature of this invention is that a moving-picture decoding apparatus for decoding encoding information by using a moving-picture encoding apparatus having the second feature, the moving-picture decoding apparatus comprises a decoding unit configured so that by using the motion vector information, a prediction value of the unit block is acquired from a locally-decoded picture of a previously encoded unit block, the thus acquired prediction value is produced as a pixel value of the locally-decoded picture of the unit block thereby to decode a picture of a unit block, the picture being encoded by an encoding mode for encoding that relies only on inference based on the encoding information of the previously encoded unit block.

The fourteenth feature of this invention is that a moving-picture decoding apparatus for decoding encoding information generated by a moving-picture encoding apparatus having the third feature, the moving-picture decoding apparatus comprises a decoding unit configured so that a value equivalent to an average value of the prediction errors is calculated from the DC component of the orthogonal transformation result relative to the prediction errors, the thus calculated value is added to a prediction value of the encoding mode that relies only on inference based on the encoding information of a previously encoded unit block so as to encode a picture of the unit block thereby to produce the thus calculated value as the pixel value of the locally-decoded picture of the unit block, whereby the picture of the unit block encoded by the encoding mode for encoding by relying only on the inference from the encoding information of the previously encoded unit block is decoded.

The fifteenth feature of this invention is that a moving-picture decoding apparatus for decoding encoding information generated by a moving-picture encoding apparatus having the fourth feature, the moving-picture decoding apparatus comprises a decoding unit configured so that the value equivalent to the average value of the prediction errors is added to a prediction value of the encoding mode that relies only on inference based on the encoding information of the previously encoded unit block so as to encode a picture of the unit block thereby to produce the thus calculated value as a pixel value of the locally-decoded picture of the unit block, whereby the picture of the unit block encoded by the encoding mode for encoding by relying only on the inference based on the encoding information of the unit block is decoded.

The sixteenth feature of this invention is that a moving-picture decoding apparatus for decoding encoding information generated by a moving-picture encoding apparatus having the fifth feature, the moving-picture decoding apparatus comprises a decoding unit configured so that according to selection of one of the motion vector information and the DC component of the orthogonal transformation result relative to the prediction error, the motion vector information is used to acquire a prediction value of the unit block from a locally-decoded picture of a previously encoded unit block, and the thus acquired prediction value is produced as a pixel value of the locally-decoded picture of the unit block, or from the DC component of the orthogonal transformation result relative to the prediction errors, a value equivalent to an average value of the prediction errors is calculated, the thus calculated value is added to a prediction value of an encoding mode that relies only on inference based on the encoding information of the previously encoded unit block so as to encode a picture of the unit block, and the thus calculated value is decoded as the pixel value of the locally-decoded picture of the unit block.

The seventeenth feature of this invention is that a moving-picture decoding apparatus for decoding encoding information generated by a moving-picture encoding apparatus having the sixth feature, the moving-picture decoding apparatus comprises a decoding unit configured so that according to selection of one of the motion vector information and the value equivalent to the average value of the prediction errors, the motion vector information is used to acquire a prediction value of the unit block from a locally-decoded picture of a previously encoded unit block, and the thus acquired prediction value is produced as a pixel value of the locally-decoded picture of the unit block, or the value equivalent to an average value of the prediction errors is added to a prediction value of an encoding mode that relies only on inference based on the encoding information of the previously encoded unit block so as to encode a picture of the unit block, and the thus calculated value is decoded as the pixel value of the locally-decoded picture of the unit block.

The present invention is also characterized by being a moving-picture decoding apparatus for decoding the encoding information encoded by the above-described moving-picture encoding apparatus. In the case of the moving-picture decoding apparatus, by using decoding unit having a configuration similar to that of the locally-decoded-picture producing unit, the moving picture can be decoded.

According to the present invention, it is possible to improve a prediction performance in an encoding mode that relies only on inference based on encoding information of a previously encoded unit block so as to encode a picture of the unit block. Thus, it is possible to perform high-compression encoding and decoding on a high-resolution picture, and at the same time, to improve the prediction performance.

### BRIEF DESCRIPTION OF THE DRAWINGS

FIG. 1 is a block diagram showing a first embodiment of a moving-picture encoding apparatus of the present invention.

FIG. 2 is a block diagram showing a configuration example of a skip encoding unit in FIG. 1.

FIG. 3 is a block diagram showing a detailed configuration of an MV-information producing unit in FIG. 2.

FIG. 4 is a block diagram showing a configuration example of the skip encoding unit in a second embodiment of the moving-picture encoding apparatus of the present invention.

FIG. 5 is a block diagram showing a third embodiment of the moving-picture encoding apparatus of the present invention.

FIG. 6 is a block diagram showing a first embodiment of a moving-picture decoding apparatus of the present invention.

FIG. 7 is a block diagram showing a configuration example of a skip decoding unit in FIG. 6.

FIG. 8 is a block diagram showing a configuration example of the skip decoding unit in a second embodiment of the moving-picture decoding apparatus of the present invention.

FIG. 9 is a block diagram showing a third embodiment of the moving-picture decoding apparatus of the present invention.

FIG. 10 is a block diagram showing the configuration of a conventional skip encoding unit.

### DETAILED DESCRIPTION OF THE PREFERRED EMBODIMENTS

With reference to drawings, the present invention will be described below. First, a moving-picture encoding apparatus of the present invention will be described.

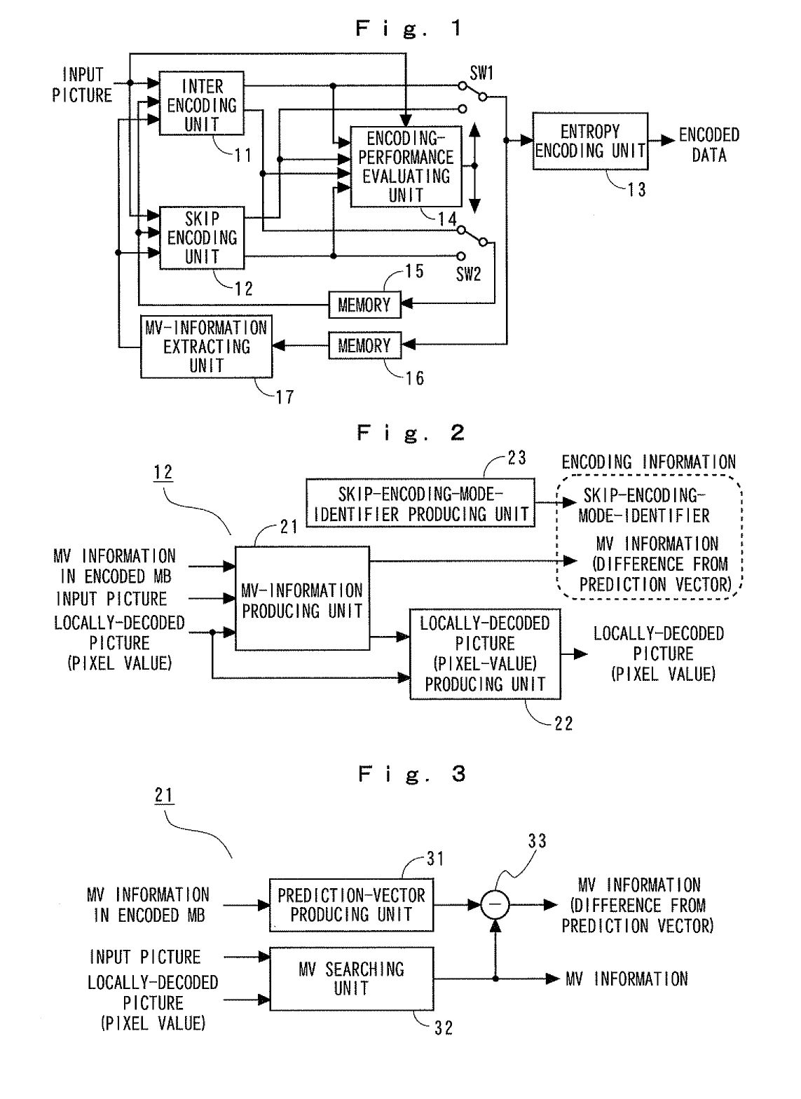

FIG. 1 is a block diagram showing a first embodiment of a moving-picture encoding apparatus of the present invention. The moving-picture encoding apparatus according to the first embodiment includes: an inter encoding unit 11; a skip encoding unit 12; an entropy encoding unit 13; an encoding-performance evaluating unit 14; memories 15 and 16; a motion-vector (MV: Motion Vector)-information extracting unit 17; and switches SW1 and SW2.

An input picture is input to the inter encoding unit 11 from outside. The inter encoding unit 11 is input with the input picture, a locally-decoded picture of a previously encoded MB from the memory 15, and MV information in an adjacent, previously encoded MB from the MV-information extracting unit 17, and performs inter encoding based on the motion compensation prediction to produce encoding information. The encoding information comprises prediction error information and the MV information. The inter encoding unit 11 outputs the encoding information to the entropy encoding unit 13, the memory 16, and the encoding-performance evaluating unit 14. The inter encoding unit 11 decodes the encoding information to produce a locally-decoded picture, and outputs it to the memory 15 and the encoding-performance evaluating unit 14.

The skip encoding unit 12 is input with the input picture, the locally-decoded picture of the previously encoded MB from the memory 15, and the MV information in an adjacent, previously encoded MB from the MV-information extracting unit 17, and performs encoding that is similar to the inter encoding by relying only on inference based on the encoding information of the previously encoded MB so as to produce the encoding information. The encoding information comprises identification information indicating that skip encoding is performed and encoding information secondarily imparted to the identification information. The secondarily imparted encoding information will be described later. The skip encoding unit 12 outputs the encoding information to the entropy encoding unit 13, the memory 16, and the encoding-performance evaluating unit 14. The skip encoding unit 12 decodes the encoding information to produce a locally-decoded picture, and outputs it to the memory 15 and the encoding-performance evaluating unit 14.

The entropy encoding unit 13 binarizes the encoding information output from the inter encoding unit 11 and the skip encoding unit 12 by way of entropy encoding so as to produce encoded data.

The encoding-performance evaluating unit 14 is input with the input picture, the encoding information and the locally-decoded picture output from the inter encoding unit 11, and the encoding information and the locally-decoded picture output from the skip encoding unit 12, compares the encoding performances between the inter encoding and the skip encoding, and outputs a control signal used for selecting encoding having a superior encoding performance. The encoding performances of the inter encoding and the skip encoding can be determined by using a magnitude of an evaluation value that is calculated based on encoding error and code amount, for example. The control signal is output to the switches SW1 and SW2 in order to select one of the inter encoding and the skip encoding.

The memory 15 stores the locally-decoded pictures output from the inter encoding unit 11 and the skip encoding unit 12. From the memory 15, the locally-decoded picture is appropriately read out and used in encoding processes in the inter encoding unit 11 and the skip encoding unit 12.

The memory 16 stores the encoding information output from the inter encoding unit 11 and the skip encoding unit 12. The encoding information is appropriately read out from the memory 16, and output to the MV-information extracting unit 17.

The MV-information extracting unit 17 is input with the encoding information from the memory 16, extracts the MV information from the encoding information, and outputs it to the inter encoding unit 11 and the skip encoding unit 12.

The switches SW1 and SW2 switch the inter encoding mode and the skip encoding mode according to the control signal from the encoding-performance evaluating unit 14. That is, the switches SW1 and SW2 switch whether the MB is encoded by one of the two encoding systems, i.e., the inter encoding and the skip encoding. When the switches SW1 and SW2 are switched to one side (upper side of the drawing), the inter encoding mode is established, and when switched to the other (lower side of the drawing), the skip encoding mode is established.

The moving-picture encoding apparatus of the present invention is characterized, in particular, by the skip encoding unit 12. FIG. 2 is a block diagram showing a configuration example of the skip encoding unit 12 in FIG. 1. The skip encoding unit 12 includes: an MV-information producing unit 21; a locally-decoded picture (pixel-value) producing unit 22; and a skip-encoding-mode-identifier producing unit 23.

The MV-information producing unit 21 is input with the input picture, the locally-decoded picture (pixel value) of the previously encoded MB, and the MV information in the adjacent, previously encoded MB, and produces encoding information secondarily imparted to the encoding information in the skip encoding. In the case of the present example, the secondarily imparted encoding information is the MV information (a difference from a prediction vector). The MV-information producing unit 21 produces also the MV information of the MB.

The locally-decoded picture (pixel-value) producing unit 22 is input with the MV information produced by the MV-information producing unit 21 and the locally-decoded picture (pixel value) of the previously encoded MB, and produces the locally-decoded picture (pixel value) of the MB. The locally-decoded picture (pixel value) of the MB is produced as follows: the locally-decoded picture (pixel value) of a reference destination indicated by the MV information is acquired, and the pixel value is used as the locally-decoded picture (pixel value) of the MB. The locally-decoded picture (pixel value) produced by the locally-decoded-picture (pixel-value) producing unit 22 is output to the encoding-performance evaluating unit 14 and the memory 15 (FIG. 1).

The skip-encoding-mode-identifier producing unit 23 produces a skip-encoding-mode identifier indicating that the MB is encoded by the skip encoding. The skip-encoding-mode identifier is 1-bit flag information, for example, and results in the encoding mode information.

The skip-encoding-mode identifier from the skip-encoding-mode-identifier producing unit 23 and the MV information from the MV-information producing unit 21 are output, as the encoding information, to the entropy encoding unit 13 (FIG. 1). In the entropy encoding unit 13, the encoding information obtained by adding the MV information to the conventional encoding information (skip-encoding-mode identifier) is subjected to entropy encoding.

FIG. 3 is a block diagram showing a detailed configuration of the MV-information producing unit 21 in FIG. 2. The MV-information producing unit 21 includes: a prediction-vector producing unit 31; an MV searching unit 32; and a subtractor 33.

The prediction-vector producing unit 31 is input with the MV information in the adjacent, previously encoded MB, and from the MV information, produces the prediction vector in the MB by using a median prediction.

The MV searching unit 32 is input with the input picture and the locally-decoded picture (pixel value) of the previously encoded MB, and searches an original picture of the MB to evaluate a position at which there is the smallest error in the previously encoded pictures (locally-decoded pictures). In this way, a vector (MV information) to the position is produced.

In an existing standard system, the MV information is not directly encoded, and a difference from the prediction vector is encoded. To make a match for this, the subtractor 33 produces the MV information (difference from the prediction vector) used for encoding the MV information. In addition, the MV information from the MV searching unit 32 is used in order to perform a motion compensation prediction in the locally-decoded picture (pixel-value) producing unit 22 (FIG. 2) arranged at a later stage.

In the moving-picture encoding apparatus according to the first embodiment, the encoding information in the skip encoding mode is imparted with the MV information (difference from the prediction vector) as the secondary encoding information. In this way, the prediction performance is improved.

Next, a second embodiment of the moving-picture encoding apparatus of the present invention will be described. The moving-picture encoding apparatus according to the second embodiment is configured similar to the apparatus in FIG. 1; however, the configuration of the skip encoding unit 12 differs, and the encoding information secondarily imparted to the encoding information in the skip encoding differs.

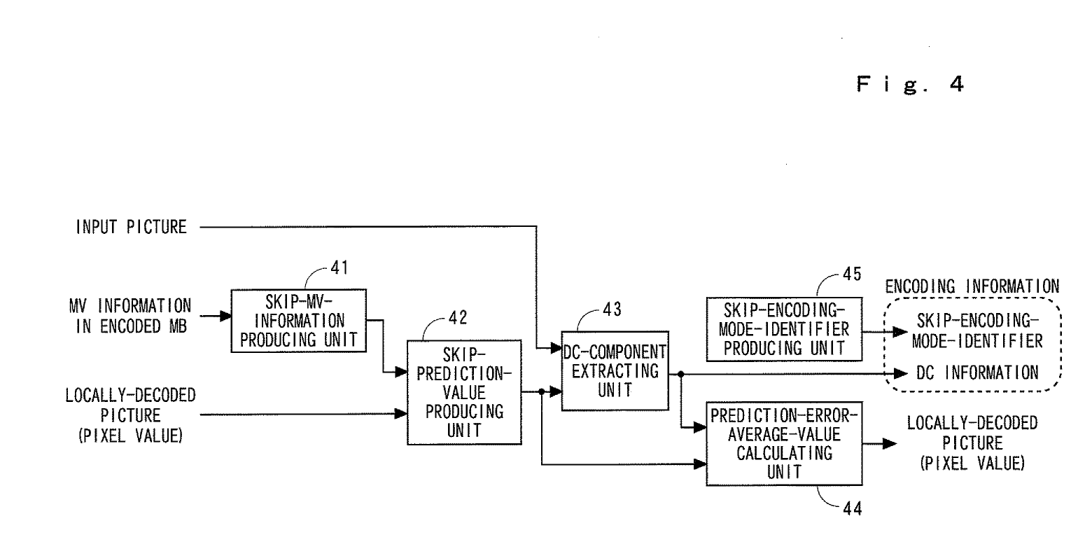

FIG. 4 is a block diagram showing a configuration example of the skip encoding unit 12 in the moving-picture encoding apparatus according to the second embodiment. The skip encoding unit 12 of the moving-picture encoding apparatus according to the second embodiment includes: a skip-MV-information producing unit 41; a skip-prediction-value producing unit 42; a DC-component extracting unit 43; a prediction-error-average-value calculating unit 44; and a skip-encoding-mode-identifier producing unit 45.

The skip-MV-information producing unit 41 is input with the MV information in the adjacent, previously encoded MB, and produces skip MV information in the MB by using a median prediction of the MV information. The skip MV information is output to the skip-prediction-value producing unit 42.

The skip-prediction-value producing unit 42 is input with the skip MV information from the skip-MV-information producing unit 41 and the locally-decoded picture (pixel value) of the previously encoded MB, and produces a skip prediction value of the MB.

The skip prediction value of the MB is produced as follows: the locally-decoded picture (pixel value) of a reference destination indicated by the skip MV information is acquired, and the pixel value is used as the skip prediction value of the MB. The skip prediction value produced by the skip-prediction-value producing unit 42 is output to the DC-component extracting unit 43 and the prediction-error-average-value calculating unit 44.

The DC-component extracting unit 43 is input with the input picture and the skip prediction value from the skip-prediction-value producing unit 42, and extracts a DC component of an orthogonal transformation result of the prediction error in the MB. An orthogonal transformation is DCT, for example. The DC component extracted by the DC-component extracting unit 43 is output to the prediction-error-average-value calculating unit 44.

The prediction-error-average-value calculating unit 44 is input with the skip prediction value from the skip-prediction-value producing unit 42 and the DC component from the DC-component extracting unit 43, and produces the locally-decoded picture (pixel value) of the MB. The locally-decoded picture (pixel value) of the MB is produced by adding an average value of the prediction errors obtained from the DC component, to the skip prediction value The locally-decoded picture (pixel value) produced by the prediction-error-average-value calculating unit 44 is output to the encoding-performance evaluating unit 14 and the memory 15 (FIG. 1).

The skip-encoding-mode-identifier producing unit 45 produces a skip-encoding-mode identifier indicating that the MB is encoded by the skip encoding. The skip-encoding-mode identifier is 1-bit flag information, for example, and results in the encoding mode information.

The skip-encoding-mode identifier from the skip-encoding-mode-identifier producing unit 45 and the DC component from the DC-component extracting unit 43 are output, as the encoding information, to the entropy encoding unit 13 (FIG. 1). In the entropy encoding unit 13, the encoding information obtained by adding the DC component to the conventional encoding information (skip-encoding-mode identifier) is subjected to entropy encoding.

The moving-picture encoding apparatus according to the second embodiment of the present invention attempts to improve the prediction performance by imparting the encoding information in the skip encoding mode with the DC component (as the secondary encoding information) of the orthogonal transformation result of the prediction error.

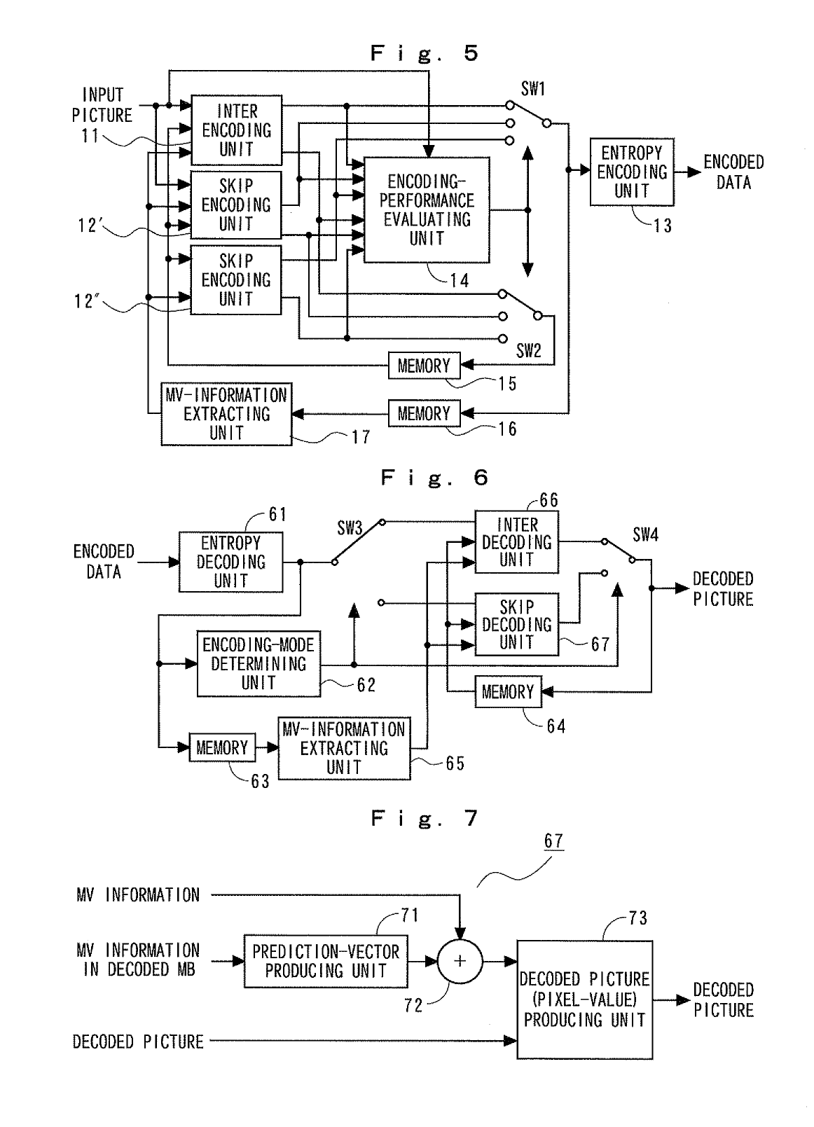

Next, a third embodiment of the moving-picture encoding apparatus of the present invention will be described. The moving-picture encoding apparatus according to the third embodiment has a configuration shown in FIG. 5, and is capable of selectively using the skip encoding units in FIG. 2 and FIG. 4. In FIG. 5, the same reference numerals are assigned to components identical or similar to those in FIG. 1.

The moving-picture encoding apparatus according to the third embodiment includes: the inter encoding unit 11; a skip encoding unit 12′; a skip encoding unit 12″; the entropy encoding unit 13; the encoding-performance evaluating unit 14; the memories 15 and 16; the MV-information extracting unit 17; and the switches SW1 and SW2. The skip encoding unit 12′ has the same configuration as that shown in FIG. 2, and the skip encoding unit 12″ has the same configuration as that shown in FIG. 4.

In the moving-picture encoding apparatus according to the third embodiment, the input picture, the encoding information and the locally-decoded picture of the previously encoded MB from the inter encoding unit 11, and the encoding information and the locally-decoded picture of the previously encoded MB from the skip encoding units 12′ and 12″, are input to the encoding-performance evaluating unit 14.

The encoding-performance evaluating unit 14 compares encoding performances of the inter encoding in the inter encoding unit 11, of the skip encoding in the skip encoding unit 12, and of the skip encoding in the skip encoding unit 12″, and outputs a control signal used for selecting the encoding having a superior encoding performance.

According to the control signal from the encoding-performance evaluating unit 14, the switches SW1 and SW 2 switch among the inter encoding mode by the inter encoding unit 11, the skip encoding mode by the skip encoding unit 12′, and the skip encoding mode by the skip encoding unit 12″. Operations of other components are similar to those in FIG. 1 to FIG. 4, and thus, description is omitted. In addition, in the third embodiment, in order to identify the encoding by the inter encoding unit 11, the skip encoding unit 12′, and the skip encoding unit 12″, at least a 2-bit skip-encoding-mode identifier is needed.

Next, a moving-picture decoding apparatus of the present invention will be described. The moving-picture decoding apparatus of the present invention is for decoding the encoding information encoded by the moving-picture encoding apparatus. The moving picture can be decoded by using a configuration similar to that of the locally-decoded picture producing unit of the moving-picture encoding apparatus.

FIG. 6 is a block diagram showing a first embodiment of the moving-picture decoding apparatus of the present invention. The moving-picture decoding apparatus according to the first embodiment is for decoding the moving picture encoded by the moving-picture encoding apparatus according to the first embodiment, and includes: an entropy decoding unit 61; and encoding-mode determining unit 62; memories 63 and 64; an MV-information extracting unit 65; an inter decoding unit 66; a skip decoding unit 67; and switches SW3 and SW4.

The encoded data from the moving-picture encoding apparatus according to the first embodiment is input to the entropy decoding unit 61. The entropy decoding unit 61 decodes the encoded data so as to produce the encoding information. The encoding information is output to the encoding-mode determining unit 62 and the memory 63, and also output through the switch SW3 to the inter decoding unit 66 or the skip decoding unit 67.

The encoding-mode determining unit 62 extracts the encoding mode information from the encoding information from the entropy decoding unit 61, determines whether the MB has been subjected to the inter encoding or to the skip encoding, and outputs a control signal used for switching the switches SW3 and SW4.

The memory 63 stores the encoding information from the entropy decoding unit 61, and appropriately outputs it to the MV-information extracting unit 65. The MV-information extracting unit 65 extracts the MV information from the encoding information from the memory 63. The MV information extracted by the MV-information extracting unit 65 is output to the inter decoding unit 66 or to the skip decoding unit 67.

The inter decoding unit 66 is input with the encoding information (the prediction error information and the MV information) from the entropy decoding unit 61, the MV information in the previously decoded MB from the MV-information extracting unit 65, and the previously decoded picture from the memory 64, and performs the inter decoding. That is, the prediction value and the prediction error are calculated so as to produce a decoded picture of the MB.

The skip decoding unit 67 is input with the encoding information from the entropy decoding unit 61, the MV information in the previously decoded MB from the MV-information extracting unit 65, and the previously decoded picture from the memory 64, and performs the skip decoding. That is, the prediction value is acquired so as to produce a decoded picture of the MB.

The decoded pictures produced by the inter decoding unit 66 and the skip decoding unit 67 are forwarded as the output of the moving-picture decoding apparatus, and at the same time, stored in the memory 66. The decoded pictures stored in the memory 66 are appropriately output to the inter decoding unit 66 and the skip decoding unit 67.

The switches SW3 and SW4 are controlled, by the control signal from the encoding-mode determining unit 62, to be switched so that the encoding information of the MB that has been subjected to the inter encoding is decoded on the side of the inter decoding unit 66 (upper side of the figure) and the encoding information of the MB that has been subjected to the skip encoding is decoded on the side of the skip decoding unit 67 (lower side of the figure).

FIG. 7 is a block diagram showing a configuration example of the skip decoding unit 67 in the moving-picture decoding apparatus according to the first embodiment. The skip decoding unit 67 in the moving-picture decoding apparatus according to the first embodiment includes: a prediction-vector producing unit 71; an adder 72; and a decoded picture (pixel-value) producing unit 73.

The prediction-vector producing unit 71 is input with the MV information in the decoded MB from the MV-information extracting unit 65 (FIG. 6), produces the prediction vector by way of a median prediction from the MV information in an adjacent decoded MB, and outputs it to the adder 72.

The adder 72 adds the MV information (difference from the prediction vector) or encoding information from the entropy decoding unit 61, to the prediction vector from the prediction-vector producing unit 71 so as to produce the MV information in the MB.

The decoded picture (pixel-value) producing unit 73 produces the decoded picture (pixel value) of the MB based on the MV information from the adder 72 and the decoded picture from the memory 64 (FIG. 6). That is, the unit 73 acquires the decoded picture (pixel value) of the reference destination indicated by the MV information from the adder 72, and uses the acquired picture (pixel value) as a decoded picture of the MB.

Next, the moving-picture decoding apparatus of a second embodiment of the present invention will be described. The moving-picture decoding apparatus according to the second embodiment is configured similar to that in FIG. 6, but differs in that the skip decoding unit 67 is configured to decode the moving picture encoded by the moving-picture encoding apparatus according to the second embodiment.

FIG. 8 is a block diagram showing a configuration example of the skip decoding unit 67 in the moving-picture decoding apparatus according to the second embodiment. The skip decoding unit 67 in the moving-picture decoding apparatus according to the second embodiment includes: a prediction-error-average-value determining unit 81; a skip-MV-information producing unit 82; a skip-prediction-value producing unit 83; and an adder 84.

The prediction-error-average-value determining unit 81 is input with DC information or encoding information from the entropy decoding unit 61, and calculates a value equivalent to an average value of the prediction errors (prediction error average value).

The skip-MV-information producing unit 82 is input with the MV information in the previously decoded MB from the MV-information extracting unit 65 (FIG. 6), and produces skip MV information in the MB by way of the median prediction from the MV information in the adjacent, previously decoded MB.

The skip-prediction-value producing unit 83 is input with the skip MV information from the skip-MV-information producing unit 82 and the previously decoded picture from the memory 64 (FIG. 6), and produces the skip prediction value of the MB. That is, the unit 83 acquires the decoded picture (pixel value) of a reference destination indicated by the skip MV information from the skip-MV-information producing unit 82, and uses the acquired picture (pixel value) as the skip prediction value of the MB.

The adder 84 adds the prediction error average value from the prediction-error-average-value determining unit 81 and the skip prediction value from the skip-prediction-value producing unit 83, and outputs a decoded picture (pixel value) of the MB.

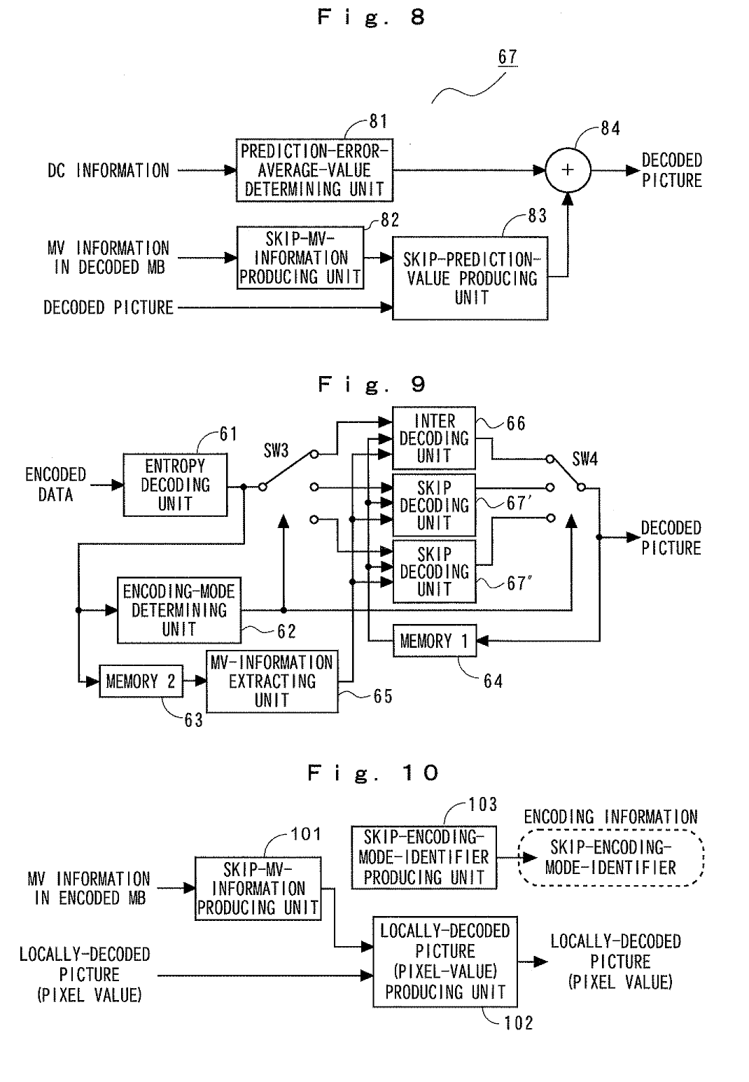

Next, the moving-picture decoding apparatus according to a third embodiment of the present invention will be described. The moving-picture decoding apparatus according to the third embodiment includes a configuration shown in FIG. 9, and is configured to decode a moving picture encoded by the moving-picture encoding apparatus according to the third embodiment. In FIG. 9, the same reference numerals are assigned to the same or equivalent portions as those in FIG. 6.

The moving-picture decoding apparatus according to the third embodiment includes: an entropy decoding unit 61; an encoding-mode determining unit 62; memories 63 and 64; an MV-information extracting unit 65; an inter decoding unit 66; a skip decoding unit 67′; a skip decoding unit 67″; and switches SW3 and SW4. The skip decoding unit 67′ has a configuration shown in FIG. 7, and the skip decoding unit 67″ has a configuration shown in FIG. 8.

The encoding-mode determining unit 62 extracts the encoding mode information from the encoding information from the entropy decoding unit 61, and determines whether the MB has been subjected to the inter encoding or to the skip encoding and further determines whether the skip encoding is performed by using the configuration shown in FIG. 2 or shown in FIG. 4, and outputs a control signal used for switching the switches SW3 and SW4.

The switches SW3 and SW4 are controlled by the control signal from the encoding-mode determining unit 62. The encoding information of the MB that has been subjected to the inter encoding is decoded by the inter decoding unit 66, the encoding information of the MB that has been subjected to the skip encoding as shown in FIG. 2 is decoded by the skip decoding unit 67′, and the encoding information of the MB that has been subjected to the skip encoding as shown in FIG. 4 is decoded by the skip decoding unit 67″. Operations at the other components are similar to those in FIG. 6 to FIG. 8, and description is omitted.

Thus, the embodiments are described, however, the present invention is not limited to the above-described embodiments and includes various modifications. For example, in the moving-picture encoding apparatus according to the second embodiment, the DC component of the orthogonal transformation result of the prediction error, as the secondary encoding information, is imparted to the encoding information in the skip encoding mode. However, instead of the DC component, a value equivalent to the average value of the prediction errors, e.g., a value obtained by quantization of the average value of the prediction errors may be optionally imparted as the secondary encoding information. In this case, the value equivalent to the average value of the prediction errors is added to the prediction value of the encoding mode that relies only on inference based on encoding information of a previously encoded unit block so as to encode a picture of the unit block. In this way, the locally-decoded picture at the time of the encoding can be produced, and by using a similar configuration, the moving picture can be decoded.

Further, a mode for imparting the encoding information in the skip encoding mode as the secondary encoding information is added as a new encoding mode while allowing the skip encoding mode to exist as it is. In this way, the skip encoding mode and the new encoding mode can be appropriately selected. According thereto, depending on the prediction performance required in a picture subject to encoding, the skip encoding mode or the new encoding mode can be applied.

What is claimed is:

1. A moving-picture encoding apparatus, including encoding modes different in predicting method, for encoding a moving picture by adaptively switching the encoding modes by each unit block, the apparatus comprising:
an encoding mode that relies only on inference based on encoding information of a previously encoded unit block to encode a picture of a unit block; and
a unit for imparting the encoding information in the encoding mode with secondary encoding information used for improving a prediction performance.

2. The moving-picture encoding apparatus according to claim 1, wherein the secondary encoding information is motion vector information of the unit block.

3. The moving-picture encoding apparatus according to claim 1, wherein the secondary encoding information is a DC component of an orthogonal transformation result relative to a prediction error of the unit block.

4. The moving-picture encoding apparatus according to claim 1, wherein the secondary encoding information is a value equivalent to an average value of the prediction errors of the unit block.

5. The moving-picture encoding apparatus according to claim 1, wherein as the secondary encoding information, one of motion vector information of the unit block and a DC component of an orthogonal transformation result relative to a prediction error of the unit block is selectable.

6. The moving-picture encoding apparatus according to claim 1, wherein as the secondary encoding information, one of motion vector information of the unit block and a value equivalent to an average value of prediction errors of the unit block is selectable.

7. The moving-picture encoding apparatus according to claim 2, comprising a locally-decoded picture producing unit for acquiring a prediction value of the unit block from a locally-decoded picture of the previously encoded unit block by using the motion vector information to produce the prediction value as a pixel value of a locally-decoded picture of the unit block.

8. The moving-picture encoding apparatus according to claim 3, comprising a locally-decoded picture producing unit for calculating a value equivalent to an average value of the prediction errors from the DC component of the orthogonal transformation result relative to the prediction error, adding the thus calculated value to a prediction value of an encoding mode that relies only on inference based on the encoding information of the previously encoded unit block so as to encode a picture of the unit block thereby to produce the thus calculated value as a pixel value of a locally-decoded picture of the unit block.

9. The moving-picture encoding apparatus according to claim 4, comprising a locally-decoded picture producing unit for adding the value equivalent to the average value of the prediction errors to a prediction value of the encoding mode that relies only on inference based on the encoding information of a previously encoded unit block so as to encode a picture of the unit block thereby to produce the thus calculated value as a pixel value of a locally-decoded picture of the unit block.

10. The moving-picture encoding apparatus according to claim 5, comprising a locally-decoded picture producing unit configured so that according to selection of one of the motion vector information and the DC component of the orthogonal transformation result relative to the prediction error, the motion vector information is used to acquire a prediction value of the unit block from a locally-decoded picture of the previously encoded unit block, and the thus acquired prediction value is produced as a pixel value of the locally-decoded picture of the unit block, or from the DC component of the orthogonal transformation result relative to the prediction error, a value equivalent to an average value of the prediction errors is calculated, the thus calculated value is added to a prediction value of the encoding mode that relies only on inference based on the encoding information of the previously encoded unit block so as to encode a picture of the unit block, and the thus calculated value is produced as the pixel value of the locally-decoded picture of the unit block.

11. The moving-picture encoding apparatus according to claim 6, comprising a locally-decoded picture producing unit configured so that according to selection of one of the motion vector information and the value equivalent to an average value of the prediction errors, the motion vector information is used to acquire a prediction value of the unit block from a locally-decoded picture of the previously encoded unit block, and the thus acquired prediction value is produced as a pixel value of the locally-decoded picture of the unit block, or the value equivalent to the average value of the prediction errors is added to a prediction value of an encoding mode that relies only on inference based on encoding information of a previously encoded unit block so as to encode a picture of the unit block, and the thus calculated value is produced as the pixel value of the locally-decoded picture of the unit block.

12. A moving-picture decoding apparatus for decoding encoding information generated by a moving-picture encoding apparatus according to claim 1, the moving-picture decoding apparatus comprising a decoding unit for decoding a picture of a unit block, the picture being encoded by an encoding mode for encoding that relies only on inference based on encoding information of a previously encoded unit block, by also using secondary encoding information imparted to the encoding information of the unit block.

13. A moving-picture decoding apparatus for decoding encoding information by using a moving-picture encoding apparatus according to claim 2, the moving-picture decoding apparatus comprising
a decoding unit configured so that by using the motion vector information, a prediction value of the unit block is acquired from a locally-decoded picture of a previously encoded unit block, the thus acquired prediction value is produced as a pixel value of the locally-decoded picture of the unit block thereby to decode a picture of a unit block, the picture being encoded by an encoding mode for encoding that relies only on inference based on the encoding information of the previously encoded unit block.

14. A moving-picture decoding apparatus for decoding encoding information generated by a moving-picture encoding apparatus according to claim 3, the moving-picture decoding apparatus comprising
a decoding unit configured so that a value equivalent to an average value of the prediction errors is calculated from the DC component of the orthogonal transformation result relative to the prediction errors, the thus calculated value is added to a prediction value of the encoding mode that relies only on inference based on the encoding information of a previously encoded unit block so as to encode a picture of the unit block thereby to produce the thus calculated value as the pixel value of the locally-decoded picture of the unit block, whereby the picture of the unit block encoded by the encoding mode for encoding by relying only on the inference from the encoding information of the previously encoded unit block is decoded.

15. A moving-picture decoding apparatus for decoding encoding information generated by a moving-picture encoding apparatus according to claim 4, the moving-picture decoding apparatus comprising
a decoding unit configured so that the value equivalent to the average value of the prediction errors is added to a prediction value of the encoding mode that relies only on inference based on the encoding information of the previously encoded unit block so as to encode a picture of the unit block thereby to produce the thus calculated value as a pixel value of the locally-decoded picture of the unit block, whereby the picture of the unit block encoded by the encoding mode for encoding by relying only on the inference based on the encoding information of the unit block is decoded.

16. A moving-picture decoding apparatus for decoding encoding information generated by a moving-picture encoding apparatus according to claim 5, the moving-picture decoding apparatus comprising
a decoding unit configured so that according to selection of one of the motion vector information and the DC component of the orthogonal transformation result relative to the prediction error, the motion vector information is used to acquire a prediction value of the unit block from a locally-decoded picture of a previously encoded unit block, and the thus acquired prediction value is produced as a pixel value of the locally-decoded picture of the unit block, or from the DC component of the orthogonal transformation result relative to the prediction errors, a value equivalent to an average value of the prediction errors is calculated, the thus calculated value is added to a prediction value of an encoding mode that relies only on inference based on the encoding information of the previously encoded unit block so as to encode a picture of the unit block, and the thus calculated value is decoded as the pixel value of the locally-decoded picture of the unit block.

17. A moving-picture decoding apparatus for decoding encoding information generated by a moving-picture encoding apparatus according to claim 6, the moving-picture decoding apparatus comprising
a decoding unit configured so that according to selection of one of the motion vector information and the value equivalent to the average value of the prediction errors, the motion vector information is used to acquire a prediction value of the unit block from a locally-decoded picture of a previously encoded unit block, and the thus acquired prediction value is produced as a pixel value of the locally-decoded picture of the unit block, or the value equivalent to an average value of the prediction errors is added to a prediction value of an encoding mode that relies only on inference based on the encoding information of the previously encoded unit block so as to encode a picture of the unit block, and the thus calculated value is decoded as the pixel value of the locally-decoded picture of the unit block.
